(19) United States
(12) Patent Application Publication
(10) Pub. No.: US 2014/0320677 A1
(43) Pub. Date: Oct. 30, 2014

(54) PORTABLE ELECTRICAL DEVICE, EXTERNAL ENTITY, AND SYSTEM COMPRISING THEM

(71) Applicant: iStoc Oy, OULUNSALO (FI)

(72) Inventors: Jarmo JARVENPAA, OULUNSALO (FI); Hannu KAUNISKANGAS, OULUNSALO (FI)

(73) Assignee: iStoc Oy, OULUNSALO (FI)

(21) Appl. No.: 14/260,630

(22) Filed: Apr. 24, 2014

(30) Foreign Application Priority Data
Apr. 26, 2013 (FI) 20135434

(51) Int. Cl. G06K 9/00; H04N 5/232

(52) U.S. Cl. CPC G06K 9/00463; H04N 5/23203; G06K 9/00449
USPC 348/207.11; 382/128

(57) ABSTRACT

A system includes a portable electrical device and an external entity. The portable device includes: a wireless transceiver; a screen; a digital camera; a user interface and a processing unit. The external entity includes: a wireless transceiver; a memory with identification data about medical monitoring devices and a processing arrangement. The processing unit acquires medical-monitoring-device-specific data as a plug-in from the external entity and configures an image capturing application of the portable electrical device with the medical-monitoring-device-specific data. The digital camera captures an image of the screen of the medical monitoring device under control of the configured image capturing application in the processing unit, the screen displaying a medical test result of a person or an animal. The portable electrical device transmits the image through the wireless transceiver to the external entity. The wireless transceiver of the external entity receives the image from a portable electrical device.

### FIELD

The invention relates to a portable electrical device, an external entity, a system comprising them and a data transmission method.

### BACKGROUND

Most of current medical monitoring devices, especially handheld and home monitors have not any connection to a network. The medical monitoring device receives a sample from a person or from an animal directly or indirectly. An example of direct measurement is to measure temperature of a person by a thermometer, for example. An example of indirect measurement is to take a blood sample to a test structure and to insert the test structure to the medical monitoring device which shows the test result on its screen. If the user of the medical monitoring device has a need to send the data of the test result to any health care specialist, to a databank and/or even to user's own computer, the user needs to feed the data manually to his/her computer or smart phone for processing the data further or for sending the data to a remote unit. This is, however, slow and inconvenient, and has a possibility of feeding errors. Furthermore, validating and checking the results afterwards is not possible. The faultlessness of data and validity of the data and measurement of the data are critical when sending the data to database and/or to health care databases for further processing. On the other hand, the data acquisition process must be fast, reliable and easy to handle.

Recently many solutions have been developed to make the connection of the medical monitoring device to its environment more easily. Current radio technologies, such as Bluetooth, WLAN, Wi-Fi have been proposed, as well optical methods such as IrDA. Also wired connections such as USB, I2C serial bus etc. have been used. However, despite many attempts this is not going to be the main stream of devices in the market. The cost of the connection technologies in the medical monitoring devices is also too high, and high technology is not always coming without any extra problems. The medical monitoring devices with connection technologies also become more complicated which leads to more break downs and difficulties to repair them.

Hence, there is need for simple medical monitoring device and an way of transmitting the results shown by the medical monitoring device to an external entity or system.

### BRIEF DESCRIPTION

The present invention seeks to provide an improved portable electronic device, external entity and a system comprising them. According to an aspect of the present invention, there is provided a portable electrical device as specified in claim 1.

According to another aspect of the present invention, there is provided an external entity for a portable test reader apparatus in claim 5.

According to another aspect of the present invention, there is provided a system as specified in claim 14.

The invention provides an effective wireless communication of data shown on a screen of a simple medical monitoring device to an external entity.

### LIST OF DRAWINGS

Example embodiments of the present invention are described below, by way of example only, with reference to the accompanying drawings, in which

FIG. 1 illustrates an example of capturing images of the medical monitoring device;

FIG. 2 illustrates example of environment of data transfer;

FIG. 3 illustrates example of the medical monitoring device;

FIG. 4 illustrates an example external entity;

FIG. 5 illustrates example of a portable electrical device;

FIG. 6 illustrates example of structural and communicational properties of the medical monitoring device, portable electrical device and external entity;

FIG. 7 illustrates an example embodiment of portable electrical device;

FIG. 8 illustrates an example signal sequence chart;

FIGS. 9, 10 and 11 illustrate an example of a flow chart of image analysis;

FIG. 12 shows examples of data related to identification data of the measurement devices;

FIG. 13 shows examples of the measurement data criteria in the external entity; and

FIG. 14 shows examples of measured data, analysed from the images received in the external entity.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments, they are simplified diagrams that only show some structures and/or functional entities. The connections shown in these Figures may refer to logical or physical connections. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses may also comprise other functions and structures. It should be appreciated that details of some functions, structures, and the protocols used for communication are irrelevant to the actual invention. Therefore, they need not be discussed in more detail here. Although separate single entities have been depicted, different parts may be implemented in one or more physical or logical entities.

It is a purpose to be able to use a mobile phone or mobile handheld device having a digital camera, which is easy to use and easy to configure, to capture image from a medical/health monitoring device which shows alphanumerical or graphical results of a heath test such as a blood test, urine test or measurement of fever, for example.

It is also a purpose to be able to configure the mobile phone to show guidance to a user to take a proper picture of the medical monitoring device including a display.

It is further a purpose to be able to have a server with a database configured to store reference data of many medical monitoring devices. The features may be retrievable pictures and data of other features listed in memory to be found as response to search.

To send the results with the validity/reliablity data to the user of data

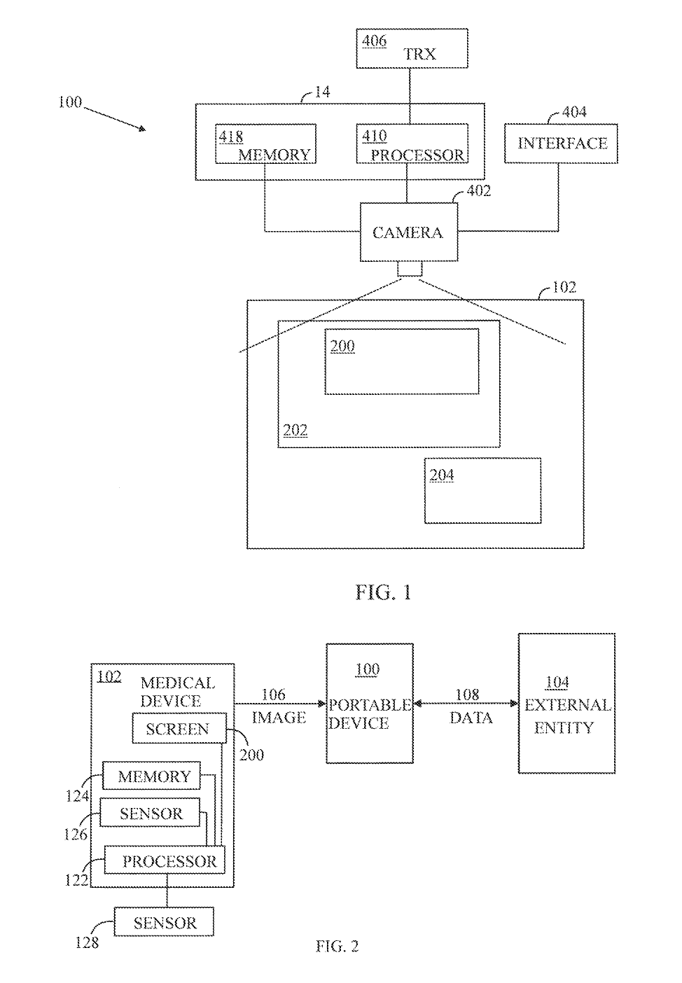

FIG. 1 presents an example configuration of capturing an image of a medical monitoring device 102 by a portable electronic device 100.

The portable electronic device 100 comprises a digital camera 402, a user interface 404, a transceiver 406 and a processing unit 14. The processing unit 14 of the portable electronic device 100 may comprise one or more processors 410 and one or more memories 418 which include one or more computer programs. The portable electronic device 100 may be a mobile phone, for example. The one or more memories 418 and the one or more computer programs together with the one or more processors 410 cause the portable electronic device 100 to perform image capturing of the medical monitoring device 102. The image capturing may be directed to the screen 200 and potentially the front face. Furthermore, the portable electronic device 100 may perform image processing.

The medical monitoring device 102 may comprise a screen 200 which shows the test result in a graphic form or in an alphanumeric form. The screen 200 may be a usual display such as a liquid crystal display (LCD) or the like. Additionally, the medical monitoring device 102 may comprise a first front area 202 and a second area 204, which may be included in the at least one image wholly or partially and then used in determining process with at least one criterion whether the captured images have good enough quality. The first front area 202 may include the screen 200.

The digital camera 402 captures at least one image of the medical monitoring device 102. The camera 402 may capture separate still images or a sequence of images in a form of video.

As there are typically reflections and the contrast of a typical LCD display or the like can be weak, it is advantageous to find a good picturing angle and condition. A video stream is instructed to be taken by the portable electronic device 100 until at least one frame quality criterion is fulfilled. The quality criteria can be set to be such as: maximum number of saturated picture elements, minimum number of pixels minimum number of pixels having signal level more than the average o background noise, at least one predetermined on-line feature found. Further processing the pixel data, by using for example connected component analysis, adjacent pixels may be analysed. This will result in characters and symbols. Minimum and maximum limit can be set for found symbols and characters, too.

If the value of one pixel is saturated it is most probably over exposed, and if there are enough pixels saturated it may mean that the image is over exposed, and thus the image processing cannot find all features.

Using such information, it may be determined whether an image is over exposed. In some cases, a certain number of pixels may have more noise than signal. The feature found may the screen 200 or a part of it such as a corner. When the criteria is fulfilled the frame from the video or set of frames or average of some frames are taken for representing the image from the medical monitoring device 102.

The processing unit 14 acquires medical-monitoring-device-specific data as a plug-in from an external entity 104 and configures an image capturing application of the portable electrical device 100 with a medical-monitoring-device-specific data. The configuration of the image capturing application includes a case where parameters of an image capturing application are somehow changed. The configuration of the image capturing application also includes a case where a totally new image capturing application is loaded to the portable electric device 100 irrespective of whether the portable electric device 100 had an image capturing application before the loading or not.

A plug-in is at least one piece of computer program which adds at least one predefined feature to a larger computer program application such as a image capturing application.

The digital camera 402 captures at least one image of a location covering the screen 200 of the medical monitoring device 102 under control of the configured image capturing application in the one or more memories 418 of processing unit 14. The portable electrical device 100 transmits the at least one image through the wireless transceiver 406 to an external entity. The location covering the screen 200 covers the screen 200 and may cover also area outside the screen 200.

The processing unit comprises one or more processors one or more memories including computer program code. The one or more memories and the computer program code configured to, with the one or more processors, cause the portable electronic device at least to: acquire medical-monitoring-device-specific data as a plug-in from an external entity; configure the image capturing application of the portable electrical device with the medical-monitoring-device-specific data; capture, under control of an image capturing application in the processing arrangement, at least one image of a location covering the screen of a medical monitoring device; and transmit the at least one image through the wireless transceiver to an external entity.

In an embodiment, the digital camera 102 may capture at least one image of a location covering the screen 200 of a medical monitoring device 102 on the basis of a user input to the user interface 404. In an embodiment, the digital camera 102 may capture at least one image of a location covering the screen 200 of a medical monitoring device 102 automatically.

In an embodiment, the processing unit 14 may have or may wirelessly receive through the wireless transceiver 406 an image capturing application for the image capturing done by in the portable electrical device 100. The first reception of the image capturing application may take place before the first capture of an image. Later updates may also be received.

In an embodiment, the processing unit 14 may have or may wirelessly receive through the wireless transceiver 406 the plug-in for configuring the image capturing application in the portable electrical device 100 medical-monitoring-device-specifically in order to capture at least one image of at least one medical monitoring device 102. The processing unit 14 may receive the plug-in repeatedly. The first reception may take place before or after the first capture of an image and later updates may be received.

In an embodiment, the portable electronic device 100 may receive, with the wireless transceiver, the plug-in from the external entity. In an embodiment, the portable electronic device 100 may receive the plug-in from a transferable memory such a USB (Universal Serial Bus) memory, CD (Compact Disc), DVD (Digital Versatile Disc), QRC (Quick Response Code) or the like given or sold the user.

In an embodiment, the screen 200 of the medical monitoring device 102 may have a specific shape which is optically distinguishable from the environment and by detecting that such a specific shape is in the angle of view area, the portable electronic device 100 may determine that at least one image may be captured. There are plenty of different medical monitoring devices 102 on the market and each model has a plenty of variants. Different medical monitoring devices 102 may have screens 200 which differ from each other by their shapes. The configured image capturing application of the portable electronic device 100 may have information about different shapes and thus it may recognize shapes of the different screens 200 and it may guide the image capturing such that image is captured when the screen 200 is properly in the viewing angle of the portable electric device 100. A mobile camera may show the outline shape of the target device, when capturing an image.

In an embodiment, the medical monitoring device 102 as a whole or partly may also have a specific shape which is optically distinguishable from the environment, and when the portable electronic device 100 detects that such a specific shape is in the angle of view area, the portable electronic device 100 may determine that at least one image may be captured. Different medical monitoring devices 102 may have shapes which differ from each other. The configured image capturing application of the portable electronic device 100 may have information about different shapes and thus it may recognize the different medical monitoring devices 102 and it may guide the image capturing such that image is captured when the screen 200 is in the viewing angle of the portable electric device 100.

In this manner, at least one image of the area of interest may be captured.

In an embodiment, the screen 200 which may also be called a display may be detected on the basis of frame lines and corner points which are searched for in each image. Then the portable electronic device 100 may set, match and compare corner masks (model of corners) to the corner areas found in an image. Based on these criteria, the area of interest which comprises the screen 200 and the test result shown in the screen 200 may be selected and approved.

In an embodiment, the portable electric device 100 may add data to or with the image it captures for validation of the image or data extracted from the image. The added data may refer to device ID, location, time, date, for example. The added data may also include at least one of the following: location, SIM number, Mobile identification number from the SW version or application, portable electric device 100 type and/or number or the like.

In order to determine a location of the portable electronic device 100, the portable electronic device 100 may comprise a positioning receiver receiving external location information, which may be utilized to generate location of the portable electronic device 100. The positioning receiver may be a receiver of a global navigation satellite system (GNSS). Such a system may be the Global Positioning System (GPS), the Global Navigation Satellite System (GLONASS), the Galileo Positioning System (Galileo), the Beidou Navigation System, The Quasi-Zenith Satellite System (QZSS), or the Indian Regional Navigational Satellite System (IRNSS), for example. The positioning receiver determines its location (longitude, latitude, and/or altitude) using signals transmitted from satellites orbiting the earth. Besides global navigation satellites, the positioning receiver may also determine its location by utilizing other known positioning techniques. It is well known that by receiving radio signals from several different base stations, a mobile phone may determine its location, for example.

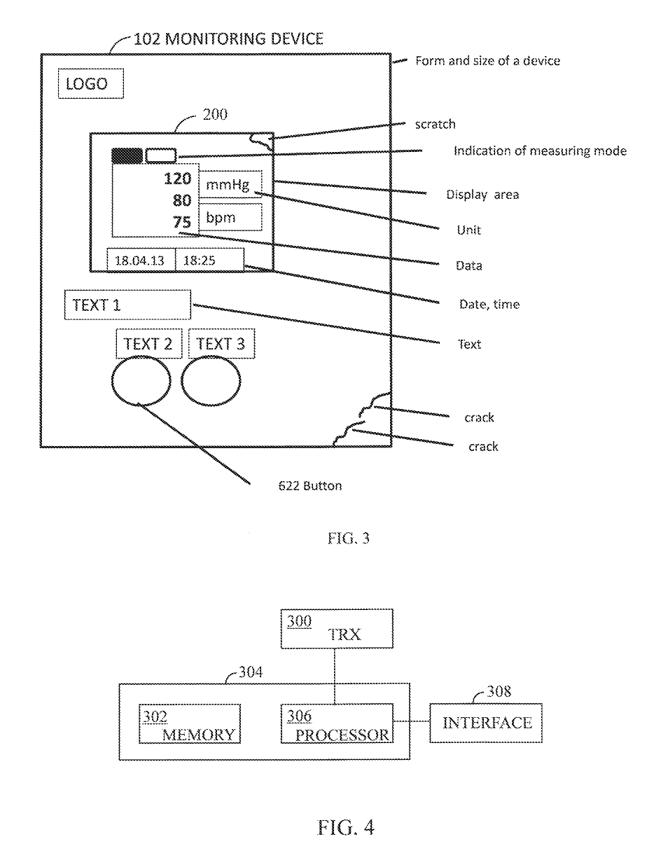

FIG. 2 illustrates an example embodiment of a general operating environment. A portable electronic device 100 captures at least one image 106 of the medical monitoring device 102. Furthermore, the portable electronic device 100 may communicate data 108 based on the image 106 and relating to the medical monitoring device 102 to an external entity 104.

The medical monitoring device 102 is capable of measuring a certain property of a target analyte in a sample. In its simplest form, the medical monitoring device 102 may be a thermometer measuring human or animal body temperature. That is the medical monitoring device 102 may have a at least one sensor for measuring a human or animal property. The medical monitoring device 102 may also be capable of detecting the presence (or absence) of the target analyte in the sample. As the medical monitoring device 102 is usually relatively simple and cheap, it may be used for various diagnostics at home or in the field, for example, but also in clinics and laboratories.

To test a target analyte, a test structure such as a test strip may be applied to human or animal secretions such as urine, saliva, blood, or stool samples, or also to other substances such as food or water. Accordingly, the test structure may be utilized for medical testing of humans or animals, or testing food and water for contaminants, ingredients and/or traces of other substances, for example.

In an example embodiment, the test structure may be used for a (clinical) point of care test for pregnancy, fertility, HIV, coronary artery disease, malaria, drug abuse, respiratory disease, or some other medical condition.

In more detail, the medical monitoring device 102 may comprise the screen 200, at least one processor 122 and one or more memory 124. Furthermore the medical monitoring device 102 may comprise an internal sensor 126 and/or an external sensor 128. The internal sensor 126 may detect a target analyte in test strip when the test strip is set in interaction with the internal sensor 126, for example. The test strip may be inserted in the medical monitoring device 102 for the measurement. Another example of the inside sensor 128 is a thermal sensor of a thermometer. An example of the outside sensor is a heart rate monitor, when a sensor part is wirelessly connected to an electric belt. The sensor part is an electrode belt which is wirelessly connected to the wrist unit which has a display.

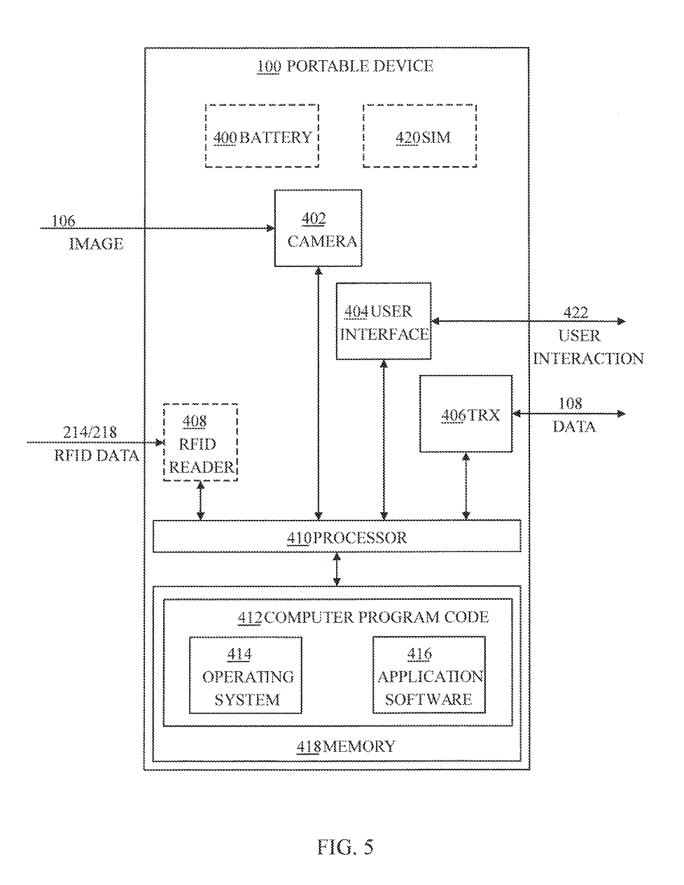

FIG. 3 illustrates the medical monitoring device 102 seen in an image. The medical monitoring device 102 may be intended for only one measurement or it may be a multimeasurement device which can deal with a plurality of tests done to a person or to an animal. Although the overall shape of the screen 200 and the shape of the medical monitoring device 102 may remain intact, each medical monitoring device 102 will still be aging, scuffing and be scratched in use. A practical solution needs configurability up-to-date capability. A portable electric device 100 needs to be updated and/or a database of the external entity 104 needs to be updated for recognition or identification of the medical monitoring device 102. A solution for recognition or identification may be adaptive to changes appearing in images of the medical monitoring device 102.

The recognition or identification of the medical monitoring device 102 may be performed using at least one of the following recognition features: form and shape of the medical monitoring device 102, logo, scratch in the screen 200, indication of the measuring mode (blood pressure test, glucose test, urea test or the like), area of the screen 200, unit of the measured result, data value of the measured result, date, time, text 1 telling the type of the measurement or the like, at least one button 250, 252 with or without their name as printed text, cracks in the casing of the medical monitoring device 102, form of the screen 200, shape or form of characters in the screen 200 or on the front face 202, type of the character for example. The type of the characters may be such as 7-segment type, matrix type or multiline type, for example. The text 1 telling the type of the measurement may be “simple glucose monitor”, “blood pressure monitor” or the like. The identification may be used for validating images for the extracting the measured data from the images. The recognition or identification of the medical monitoring device 102 may be performed in the portable electric device 100 and/or in the external entity 104. The recognition or identification procedures may also be divided between the portable electric device 100 and/or in the external entity 104 such that a part of the procedure is performed in the portable electric device 100 and the rest of the procedure is performed in the external entity 104. Some of the recognition or identification procedure parts may also be overlapping.

Due to potentially erroneous measured data a possible faking or poor quality of the image 106, the quality of the test result should be checked. The recognition features shown in FIG. 3 may be used to check the quality.

Due to erroneous measured data (wrong measurement mode, or not successful measurement) or error on the display (one LCD element broken or low battery condition etc.) the analysed data should to be checked. The recognition features shown in FIG. 3 may be used to check the quality.

Each of the recognition features stored in the portable electronic device 100 or in the external entity 104 serve as a reference which a new image or data extracted from a new image may be compared with. This is a base for recognition of the medical monitoring device 102, a quality checking procedure and criteria for an acceptance of an image and an extracted test result.

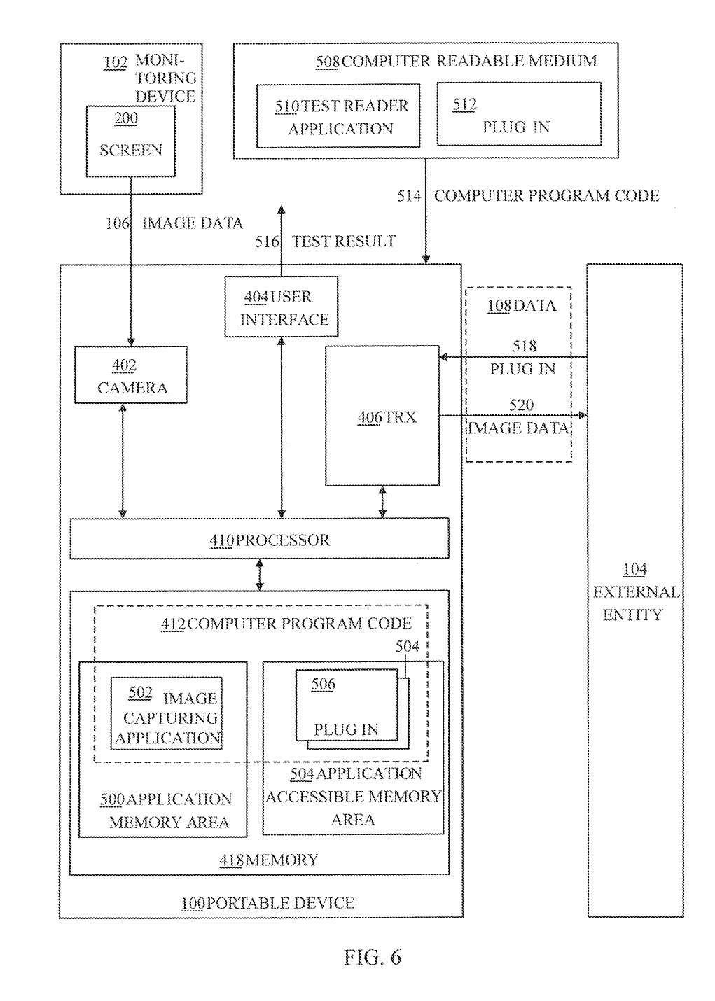

The external entity 104, shown in FIG. 4, which may be a server including cloud computing. The server may be implemented as a single server or a as a cluster of computers. The server may be maintained by any interest group comprising at least one of the following: a manufacturer of the portable electronic device 100, a distributor of the portable electronic device 100, a manufacturer of the medical monitoring device 102, a distributor of the medical monitoring device 102, a health-care organization, a service provider, or the like.

The external entity 104 may comprise, in a similar manner to the portable electronic device 100, a wireless transceiver 300; one or more memories 302 with identification data related to at least one medical monitoring device 102; and an processing arrangement 304 with at least one processor 306 and memory 302. The external entity 104 may also have a user interface 308. The wireless transceiver 300 of the external entity 104 receives at least one image of a location of a screen 200 of a medical monitoring device 102 from a portable electrical device 100, the screen 200 assumed to display a medical test result of a person or an animal. The processing arrangement 304 is configured to extract data from the at least one image 106 for regaining a result about the medical test from the at least one image 106, and for comparing the extracted data with the reference data stored in the one or more memories 302 in order to ensure validity of the result about the medical test. The reference data is any data which is associated with the medical monitoring device 102. The reference data may include a feature of the medical monitoring device 102 or it may be associated to the measured value of the medical test. The reference data may also be associated to any sign, unit or other feature present in the medical monitoring device 102 during the medical test. The comparison of the extracted data with the identification data may make the medical monitoring device 102 to be recognized.

In an embodiment, the one or more memories 302 and a computer program code are configured to, with the one or more processors 306, cause external entity 102 at least to receive at least one image 106 of a location of a screen 200 of a medical monitoring device 102 from a portable electrical device 100, the screen 200 assumed to display a medical test result of a person or an animal.

The one or more memories 302 and a computer program code are configured to, with the one or more processors 306, cause external entity 102 at least to extract data from the at least one image 106 for regaining a result about the medical test from the at least one image 106, and for comparing the extracted data with the identification data in the one or more memories 302 in order to recognize the medical monitoring device 102 for ensuring correctness of the result about the medical test.

In an embodiment the wireless transceiver 300 of the external entity 104 may wirelessly transmit a plug-in to the portable electrical device 100, the plug-in configuring the image capturing application in the portable electrical device 100 for capturing at least one image of the medical monitoring device.

In an embodiment, the plug-in guides the image capturing performed by the portable electrical device.

In an embodiment, the processing arrangement 304 may add a new identification data associated with a medical monitoring device 102 in the at least one memory 302 if the recognition of said medical monitoring device 102 fails.

In an embodiment, the processing arrangement 304 may add the new identification data associated with the medical monitoring device 102 in the at least one memory 302 only after an approval by a super user of the external entity 104.

In an embodiment, the processing arrangement 304 may compare proportions of at least one part of the medical monitoring device 102 shown in the at least one image 106 for validating the extracted test result.

In an embodiment, the processing arrangement 304 may compare the value of the extracted test result with at least one predetermined criterion for determining reliability of the test result.

In an embodiment, the processing arrangement 304 may extract the unit of the test result and compare the extracted unit with at least one reference unit stored in the one or more memories 302 for determining reliability of the test result.

In an embodiment, the external entity 104 may transmit, through the wireless transceiver 300, information about the analysis of the image back to the portable electrical device 100 for controlling further image captures.

A system may comprise the portable electrical device 100 and an external entity 104.

In an embodiment, the processing arrangement 304 of the external entity 104 may analyse the picture for recognizing the test result(s). The purpose is to recognize measurement numbers of the medical test.

In an embodiment, the external entity 104 may analyse the quality of the at least one image and results extracted from it by comparing image elements against predetermined criteria.

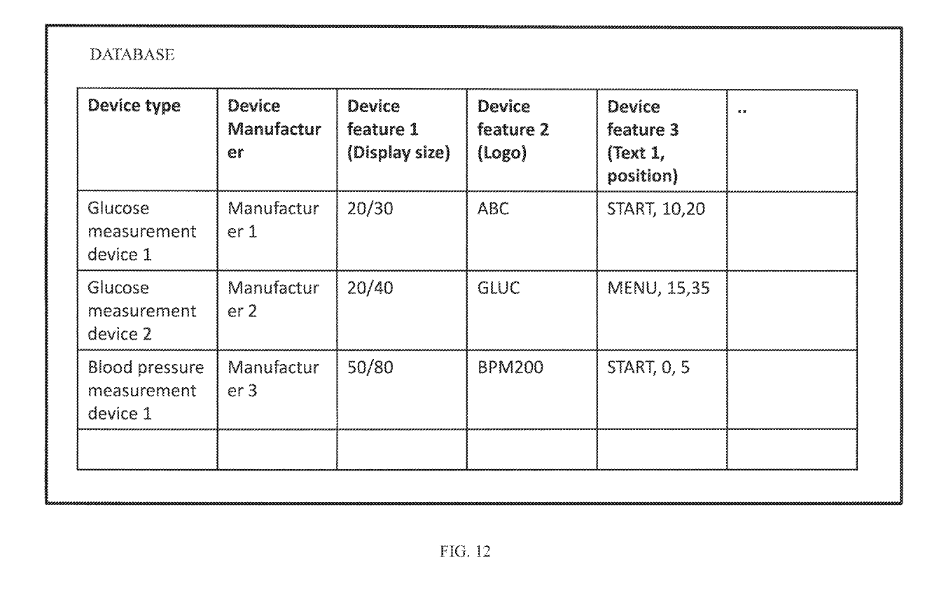

In an embodiment, the external entity 104 may analyse the at least one image to judge and recognize the measurement device. Such reference data is shown in FIG. 12.

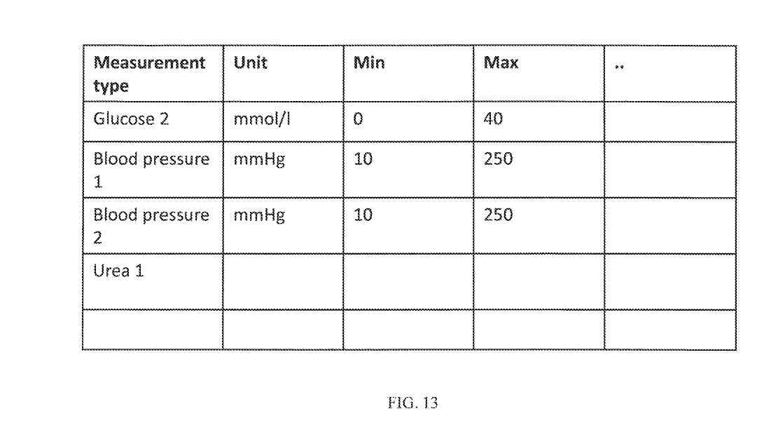

In an embodiment, the external entity 104 may analyse the reliability of the test results and validity of measured test result by comparing the extracted data against the reference data formed on the basis of the accepted measurement devices. Such reference data is shown in FIG. 13.

If a medical monitoring device is not recognized, the external entity 104 may form features of the at least one image of the new medical monitoring device and inform a super user or the like of the system to “accept” the new medical monitoring device for the system.

In an embodiment, the external entity 104 may send the test results to the user of data who may be a test person, medical care specialist or a test operator, for example.

In an embodiment, the external entity 104 may validate an image or data extracted from an image received from the portable electrical device 100 by comparing the received data such as a test result or any other extracted data to the previous corresponding data of a person or animal stored in the external entity 104. In an embodiment, the external entity 104 may validate data of an image received from the portable electrical device 100 by comparing the received data to set limits such as maximum and/or minimum, for example.

In an embodiment, the external entity 104 may validate image or data of an image received from the portable electrical device 100 by the trend of data. If the images and/or data extracted from the image doesn't vary more than a predetermined threshold the image and the data extracted from the image may be accepted.

In an embodiment, the external entity 104 may validate image or data of an image received from the portable electrical device 100 by a time and/or date indication in the display. The person may have a habit or the person may have to make the test at certain time of day or on a certain week day or on a certain day of a month or a year. If the timing is correct, an image captured at a proper time/date and data extracted from the image may be valid. If the timing is not correct, an image captured at a wrong time/date and data extracted from the image may be invalid or of low quality. However, the invalid or low quality image may be still be stored for further analysis done later or set to a further approval process. The quality level may be shown when the image is used.

In an embodiment, the external entity 104 may validate image or data of an image received from the portable electrical device 100 by comparing if the image represents the same device type as in earlier images. If the type of the medical monitoring device 102 is unchanged, an image and data extracted from it may be valid. If the type of the medical monitoring device 102 has changed, an image and data extracted from it may be invalid.

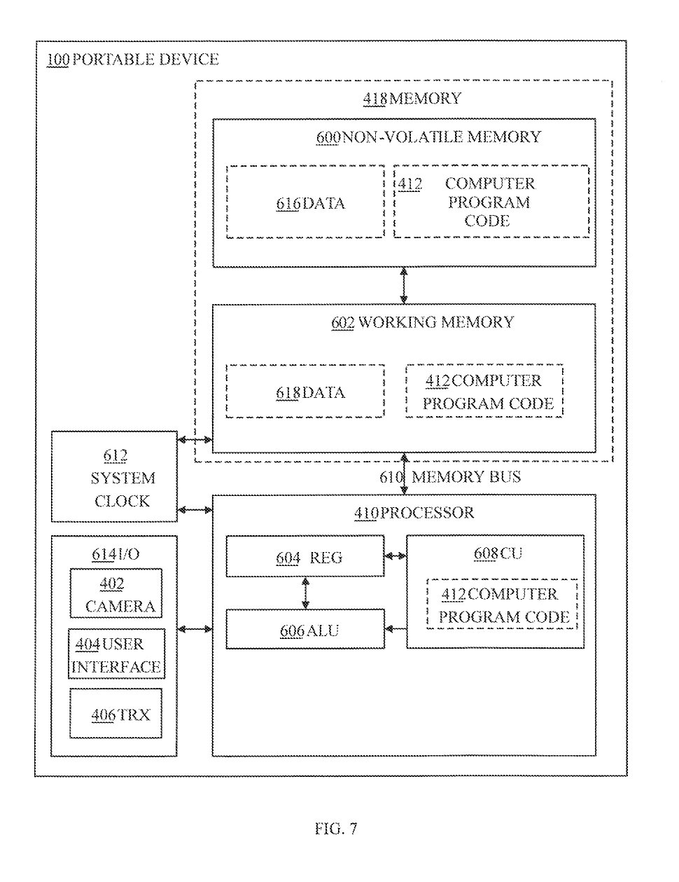

In an embodiment, the external entity 104 may validate image or data of an image received from the portable electrical device 100 by comparing if the medical monitoring device 102 is the same as in earlier images. The medical monitoring device 102 may be recognized and identified on the basis of recognition features shown in FIG. 5 (special features of a device, scratch etc.).

In an embodiment, the external entity 104 may validate image or data extracted from an image received from the portable electrical device 100 by data added to the image in portable electric device 100. The added data may refer to device ID, location, time, date, for example. The added data may also include at least one of the following: location, SIM number, Mobile identification number from the IMEI and SW version or application, portable electric device 100 type and/or number or the like.

In an embodiment, the external entity 104 may keep records and shows the latest data analysed. This may be combined with the reliability data related to validity and image and character analysis.

In an embodiment, a health care professional may get a view about how the data has been collected in the external entity 104. In an embodiment, a health care professional may get a view about the medical monitoring devices used, quality of data, information about the person who has performed the test or the like. This data shown with measurement results may be important and even crucial for a health care specialist to create trust and reliability for the health monitoring and measurements made at home.

FIG. 5 illustrates some example embodiments of the portable electronic device 100. The portable electronic device 100 may be any suitable mobile electronic apparatus. A non-exhaustive list of the types of the electronic device 100 includes: a mobile phone, a smartphone, a tablet computer, a general-purpose mobile computing device. In an example embodiment, the portable electronic device 100 may be a general-purpose off-the-shelf computing device, or a purpose-build proprietary electronic device.

The portable electronic device 100 may comprise a battery 400, a digital camera 402, a user interface 404, a wireless transceiver 406, and a radio-frequency identifier reader 408.

In an example embodiment, the electrical battery 400 which may be rechargeable or non-rechargeable may comprise one or more electrochemical cells that convert the stored energy of chemical form into electrical energy. Instead of battery 400, other suitable accumulator means may be used to store energy.

In an example embodiment, the digital camera 402 captures video or still photographs by an electronic image sensor through an optical system and records them in the one or more memories 418. The image sensor may be a CCD (Charge Coupled Device) or CMOS (Complementary Metal Oxide Semiconductor) cell, for example.

In an example embodiment, the user interface 404 implements the exchange 422 of graphical, alphanumeric/symbolic and audio information with the user of the portable electronic device 100. The user interface 404 may be realized with various techniques, such as a display, means for producing sound such as a loud speaker, for instance. The user interface 404 may also comprise a keyboard, and/or a keypad, for example. The display of the user interface 404 and the screen 200 of the medical monitoring device 102 may be a liquid crystal display, for example, but it may also be implemented by any appropriate technique, such as with a matrix of light-emitting diodes. The display may comprise an active-matrix of organic light-emitting diodes. The display may also incorporate other user interaction means, such as touch input, or haptic feedback, i.e. the display may be a touch screen. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, the user interface 404 may comprise other user interface components, for example various means for focusing a cursor (mouse, track ball, arrow keys, touch sensitive area etc.) or elements enabling audio control.

In an example embodiment, the wireless transceiver 406 may be interoperable with various wireless standard/non-standard/proprietary communication networks such as any mobile phone network, regardless of the generation (such as 2G, 3G, 4G, beyond 4G, etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), such as WLAN (Wireless Local Area Network) based on IEEE (Institute of Electrical and Electronics Engineers) 802.11 standard or its evolution versions (IEEE 802.11ac etc.), WiMAX (Worldwide Interoperability for Microwave Access, or Wi-Fi, for example.

In an example embodiment, the wireless transceiver 406, while communicating with a mobile phone network, may require a subscriber identity module (SIM) 420, which may be an integrated circuit storing subscriber data, which is network-specific information used to authenticate and identify subscribers on the cellular network. The subscriber identity module may be embedded into a removable SIM card, on a mini-SIM card, for example. Furthermore, the portable electronic device 100 may include a SIM card reader (not illustrated in FIG. 5), for example. Besides being implemented on a SIM card, the subscriber identity module 420 may be implemented with other techniques as well, such as a virtual/embedded SIM.

In an example embodiment, the portable electronic device 100 may include a RFID reader 408 capable of reading RFID data 214, 218 programmed into the electronic tag 204, 208 of the medical monitoring device 102.

The portable electronic device 100 comprises, as already earlier mentioned, one or more processors 410, and one or more memories 418 including computer program code 412.

In an example embodiment, the term ‘processor’ refers to a physical device that is capable of processing data in a computer or other digital electronic device. Depending on the processing power needed, the portable electronic device 100 may comprise several processors 410 such as parallel processors or one or more multicore processors. A non-exhaustive list of implementation techniques for the processor 410 includes, but is not limited to: logic components, standard integrated circuits, application-specific integrated circuits (ASIC), system-on-a-chip (SoC), application-specific standard products (ASSP), microprocessors, digital signal processors, special-purpose computer chips, and field-programmable gate arrays (FPGA). This is true also for processors of medical monitoring device 102 and the external entity 104.

In an example embodiment, the term ‘memory’ 418 refers to a physical device that is capable of storing the code 412 of the computer program and data on a temporary or permanent basis for use in a computer or other digital electronic device. In an example embodiment, the term ‘memory’ refers to working memory (also known as primary storage, main memory or internal storage) directly accessible to the processor. In an example embodiment, the working memory may be implemented as a random-access memory (RAM), such as a dynamic RAM, DRAM. This is true also for memories of medical monitoring device 102 and the external entity 104.

In an example embodiment, the computer program code 412 includes an operating system 414 and application software 416. The operating system may be Android, Microsoft Windows Phone, Apple iOS, Linux, or Symbian, for example. The application software 416 includes all the applications running in the portable electronic device 100.

Naturally, the portable electronic device 100 may include a number of other components but they will not be further described because the other components are not required to illustrate the present embodiments.

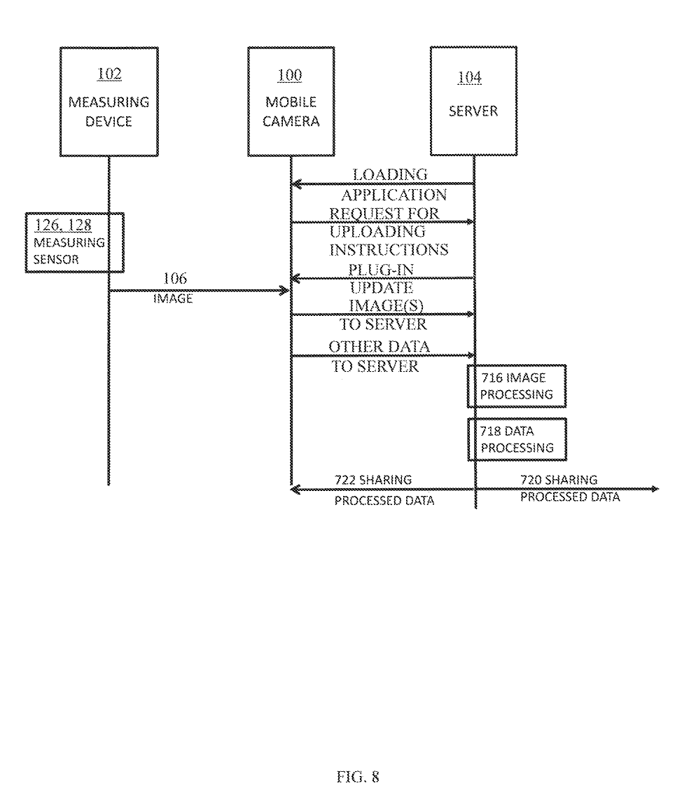

Let us next study FIG. 6, illustrating further example embodiments of the portable electronic device 100, especially the way the portable electronic device 100 interacts with the medical monitoring device 102 and the external entity 104.

The one or more memories 418 and the computer program code 412 may, with the one or more processors 410, cause the portable electronic device 100 to receive, with the wireless transceiver 406, a plug-in 518 from the external entity 104, to configure the image capturing application 502 with the received plug-in 506, and to capture, with the digital camera 402 controlled by the image capturing application 502 configured using the plug-in 506, image 106 of the screen 200 of the medical monitoring device 102. The image data 520 which may be the same the image data 106 or processed image data 106 is transferred to the external entity 104.

With this mechanism, the image capturing application 502 may be configured under control of one or more plug-ins 506, 504, i.e. the memory 418 may contain at least one plug-in, one for each different type of medical monitoring device 102.

In an example embodiment, the medical-monitoring-device-specific data acquired as the plug-in 506 from an external entity 104 may comprise at least some of the following information:
an image taking instruction for taking of the image data 106 with the digital camera 402, the image taking instruction comprising at least one of the following: manual/automatic mode, focus distance, location, focus, lighting, shooting angle.

Additionally, the medical-monitoring-device-specific data acquired as the plug-in 506 from an external entity 104 may comprise at least some of the following information:
an analysis instruction for analysis of the image of the screen 200, the analysis instruction comprising at least one of the following: optical readability, colour info, a test limit parameter, a test criterion, a test reliability parameter, a test quality parameter, a test validity parameter;
general information on the medical monitoring device 102, the general information comprising at least one of the following: an identifier of the medical monitoring device 102, a manufacturer identifier, a manufacturing date of the medical monitoring device 102, information on the use by date of the medical monitoring device 102, information on the dimensions or relative dimensions of the screen 200, information on the dimensions or relative dimensions of the medical monitoring device 102. Typically the external entity 104 has available these two pieces of information i.e. an analysis instruction and general information on the medical monitoring device 102. The test limit parameter may be quality criteria, maximum number of saturated picture elements, minimum number of pixels having signal level more than the average of background noise, minimum and maximum of adjacent pixels, minimum and maximum number of characters and symbols, color of symbols, shape of symbols, position of the symbol related to the display, for example.

Naturally, the above described information for the medical-monitoring-device-specific data acquired as the plug-in from an external entity 104 506 is just a non-limiting example embodiment. Furthermore, the following information may or may not be present in the medical-monitoring-device-specific data acquired the plug-in from the external entity 104: a name for the medical monitoring device 102, a name in the local language(s) for the medical monitoring device 102, an image analysis algorithm, a flashlight instruction (on/off/intensity), a bounding box (=an area within which the screen 200 is searched for), size and location of an aiming crosshair (or box, or other aiming aid) for the screen 200, size of the screen 200 in pixels, a minimum and maximum aspect ratio between the breadth and height of the screen 200, a minimum and maximum intensity of the stripe(s) in the screen 200, a reliability threshold for successive similar video frames, a maximum allowable deviation for the shooting angle in roll and pitch directions, an offset for said maximum allowable deviation. The information for the medical-monitoring-device-specific data acquired from an external entity 104 may be utilized in the capturing of an image and/or in an image processing. Furthermore, the information may be added to or it may be enclosed with an image transmitted to the external entity 104.

In an example embodiment, the one or more memories 418 may comprise an application memory area 500 and an application-accessible memory area 504. The computer program code of the image capturing application 502 may be stored in the application memory area 500. The one or more memories 418 and the computer program code 412 may further be configured to, with the one or more processors 410, cause the portable electronic device 100 to store the received plug-in 506 in the application-accessible memory area 504.

In an example embodiment, the one or more memories 418 and the computer program code 412 may further be configured to, with the one or more processors 410, cause the portable electronic device 100 to store the received plug-in 506 in the application-accessible memory area 504 without having to exercise any control by an authority other than the user of the portable electronic device 100.

In an example embodiment, the one or more memories 418 and the computer program code 412 may further be configured to, with the one or more processors 410, cause the portable electronic device 100 to configure the image capturing application 502 under control of the plug-in 506 without having to restart the portable electronic device 100 and/or the image capturing application 502.

In an example embodiment, the one or more memories 418 and the computer program code 412 may further be configured to, with the one or more processors 410, cause the portable electronic device 100 to configure the image capturing application 502 under control of the plug-in 506 automatically, i.e. without any user interaction, or with the user confirming the operation. Optionally, the user may be informed that the update of the plug-in 506 has been made. The user interface 404 may show the test result 516 to the user.

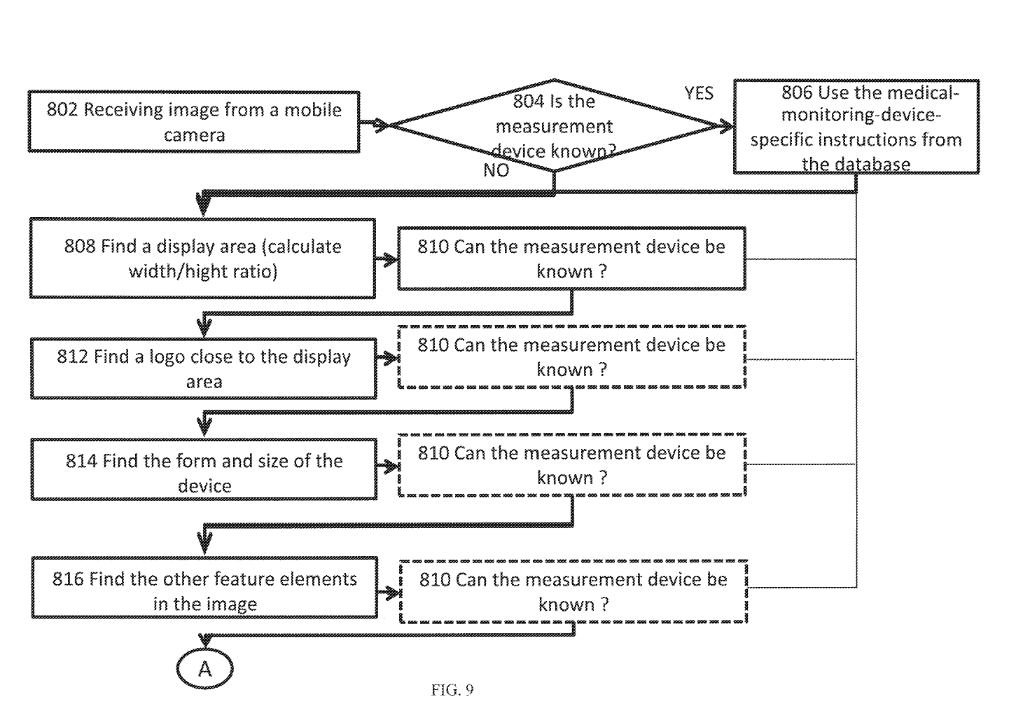

In an example embodiment illustrated in FIG. 7, the portable electronic device 100 may comprise an electronic digital computer, which may include a non-volatile memory 600 and a working memory 602 as the memory 418, the processor 410, a system clock 612 and an input/output 614 including the digital camera 402, the user interface 404, and the wireless transceiver 406. Naturally, the computer may comprise a number of other peripheral devices, not illustrated here for the sake of clarity. Also, the architecture of FIG. 7 is just one example embodiment as other feasible computing architectures may be utilized as well to implement the hardware and software of the portable electronic device 100.

In an example embodiment, the system clock 612 constantly generates a stream of electrical pulses, which cause the various transferring operations within the computer to take place in an orderly manner and with specific timing.

In an example embodiment, the processor 410 may be implemented as a microprocessor implementing functions of a central processing unit (CPU) on an integrated circuit. The CPU 410 is a logic machine executing the computer program code 412. The computer program code 412 may be coded as a computer program using a programming language, which may be a high-level programming language, such as C, C++, or Java, or a low-level programming language, such as a machine language, or an assembler. There are many ways to construct the computer program code 412 In an example embodiment, the operations of the computer program code 412 may be divided into functional modules, sub-routines, methods, classes, objects, applets, macros, etc., depending on the software design methodology and the programming language used. In modern programming environments, there are software libraries, i.e. compilations of ready-made functions, which may be utilized by the computer program code 412 for performing a wide variety of standard operations.

The CPU 410 may comprise a set of registers 604, an arithmetic logic unit (ALU) 606, and a control unit (CU) 608. The control unit 608 is controlled by the computer program code 412 transferred to the CPU 410 from the working memory 602. The working memory 602 is directly or indirectly connected to the CPU 410 via a memory bus 610 including two buses: an address bus and a data bus. The CPU 410 sends a memory address indicating the desired location of data 618 (such as the image data 106, or data 108) or computer program code 412 through the address bus, whereupon the CPU 410 reads or writes the data itself from/to the working memory 602 using the data bus.

The control unit 608 may contain a number of microinstructions for basic operations. The implementation of the microinstructions may vary, depending on the CPU design. The microprocessor 410 may also have an operating system (such as a general-purpose operating system), which may provide the computer program code 412 with system services. During running of the computer program code 412, the computer program code 412 or a part of it are transferred via the memory bus 610 from the working memory 602 into the control unit 608, wherein usually a portion of the computer program code 412 resides and controls the operation.

In an example embodiment, the non-volatile memory 600 retains the stored information even when not powered. Examples of non-volatile memory include read-only memory (ROM), flash memory, magnetic computer storage devices such as hard disk drives, and optical discs. As is shown in FIG. 7, the non-volatile memory 600 may store both data 616 and the code 412 of the computer program.

An example embodiment, illustrated in FIG. 6, provides a computer readable medium 508 comprising the computer program code 412 of the image capturing application 510 and the plug-in 512 the same as or similar to plug-in 506. Said computer program code 412, when executed on the portable electronic device 100, causes the portable electronic device 100 to perform the operations required to implement the described example embodiments. In an example embodiment, the computer program code 412 may be in source code form, object code form, or in some intermediate form. The computer-readable medium 508 may comprise at least the following: any entity or device capable of carrying 514 computer program code 412 to the portable electronic device 100, a record medium, a computer memory, a read-only memory, an electrical carrier signal, and a software distribution medium. In some jurisdictions, depending on the legislation and the patent practice, the computer-readable medium 508 may also be a telecommunications signal. In an example embodiment, the computer-readable medium 508 may be a non-transitory computer readable storage medium.

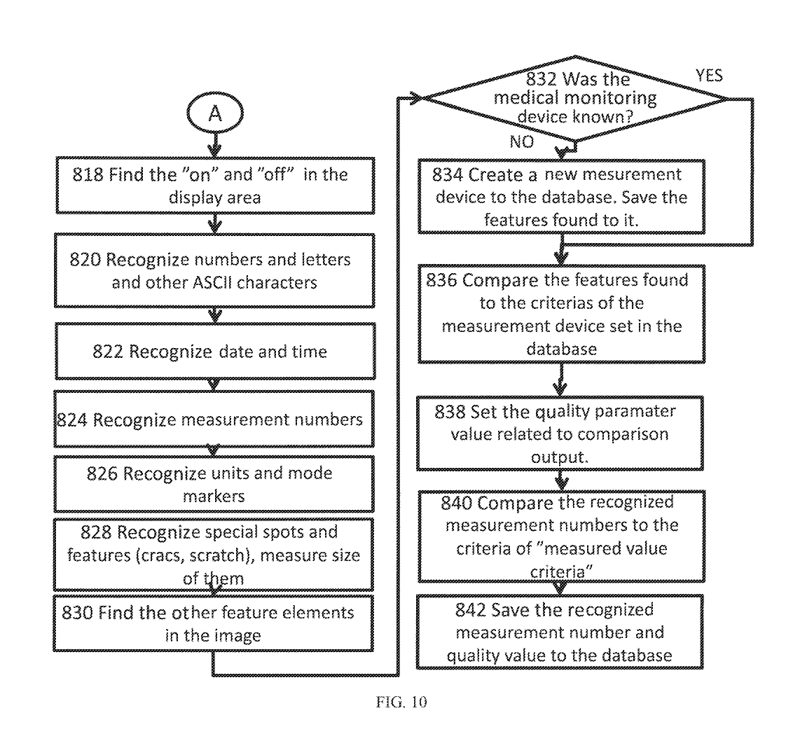

With reference to FIG. 8, examine the communication of the portable electronic device 100 and some further example embodiments in the form of a signal sequence chart. Other functions, not described in this application, may also be executed between the operations or within the operations. Some of the operations or parts of the operations may also be left out or replaced by a corresponding operation or part of the operation.

The portable electric device 100 may capture an image of the medical monitoring device 102 before or after communication with the external entity 104. The portable electric device 100 loads application from the external entity 104. The application may be associated with image capturing and/or data transfer between the portable electric device 100 and the external entity 104. The portable electric device 100 may request for uploading instructions from the external entity 104. The instructions may include an instruction to take an image, a specific instruction if a user knows the medical monitoring device, or instructions about updates of the medical monitoring device. The external entity 104 may transmit plug-in update to the portable electric device 100. The portable electric device 100 may send the at least one image to the external entity 104. The portable electric device 100 may send other data to the external server 104. The external entity 104 may perform image processing 716 and/or other data processing 718 using the processing arrangement 304. The external entity 104 may send back 722 the image data and/or other data which it has processed to the portable electric device 100. The external entity 104 may also share 720 the data it has partly or wholly with one or more data processing entity representing at least one person or an institution.

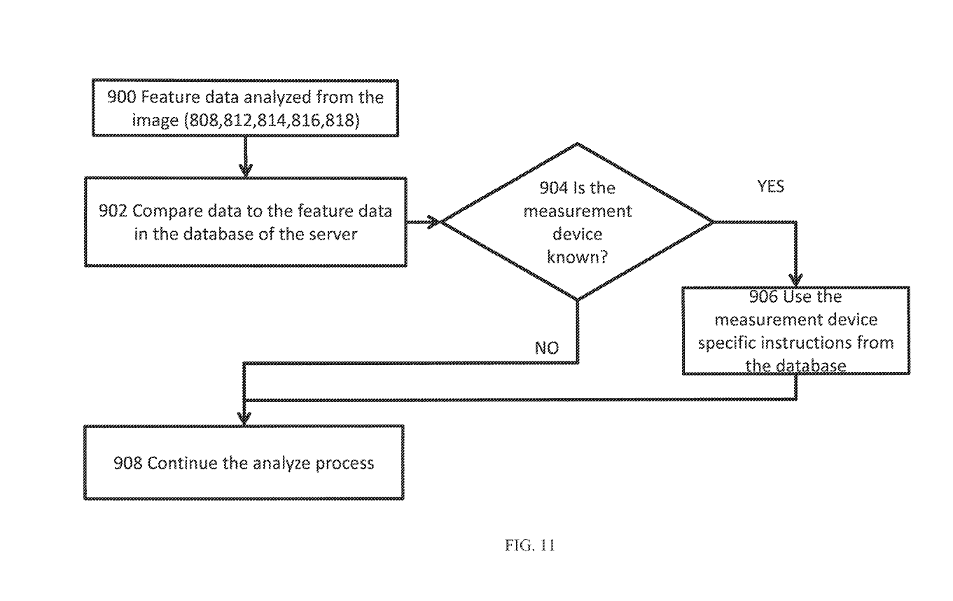

FIGS. 9 and 10 illustrate the method of image processing in the external entity 104. In step 802, the external entity 104 receives at least one image from the portable electric device 100. In step 804, the external device 104 checks if the medical monitoring device 102 is known by comparing the identification data stored in the external entity 104 and identification data extractable from the image, or the user may have selected and indicated which medical monitoring device is used. If the medical monitoring device 104 is known, the medical-monitoring-device-specific instructions may be found in step 806, and may be used in the image processing steps 808, 812, 814, 816, 818, 820, 822, 824, 826, 828, 830. If the medical monitoring device 104 cannot be recognized in one or more steps 808 to 816, then generic image processing instructions may be used for each of such image processing steps. If the medical monitoring device 104 cannot be recognized in one or more steps 808 to 830, then generic image processing instructions may be used for each of such image processing steps. The image processing steps 808, 812, 814, 816, 818, 820, 822, 824, 826, 828, 830 may all be performed. Alternatively, at least one of them may be skipped. Any number of them may be performed in arbitrary order and/or reprocessed after the medical monitoring device 102 has been recognized in at least one of the steps.

In step 808, the screen 200 is checked (its width/height ratio, for example). If the medical monitoring device 102 is recognized in step 808, the recognition step being generally presented as step 810, the medical-monitoring-device-specific instructions may be used for analysing the image further. If the medical monitoring device 102 is not recognized in step 810, a further step 812, 814, 816 may be performed.

In step 812, the logo is checked. If the medical monitoring device 102 is recognized in step 812, the medical-monitoring-device-specific instructions may be used for analysing the image further. If the medical monitoring device 102 is not recognized in step 812, a further step 808, 810, 814, 816 may be performed.

In step 814, the form and/or size of the medical monitoring device 102 is checked. If the medical monitoring device 102 is recognized in step 814, the medical-monitoring-device-specific instructions may be used for analysing the image further. If the medical monitoring device 102 is not recognized in step 814, a further step 808 to 812, 816 may be performed.

In step 816, the some other feature of the medical monitoring device 102 is checked.

In general, if the medical monitoring device 102 is recognized in any step 808 to 816, it allows to use more specific medical-monitoring-device specific instructions for all steps. Any later step may also be processed using the information available on the basis of recognition of the medical monitoring device 102. Any previous step may also be reprocessed. If the medical monitoring device 102 is not at all recognized in one or more steps 808 to 816, then generic image processing instructions may be used for each image processing step having failure in recognition.

In addition to the steps 808 to 816 a further step 818 to 830 may be performed irrespective of whether the of the medical monitoring device is recognized or not.

In step 818, “on” an “off” sign in the display area of the medical monitoring device 102 is checked. If the medical monitoring device 102 is recognized in step 818, the medical-monitoring-device-specific instructions may be used for analysing the image further.

In step 820, numbers and/or letters are checked. If the numbers and/or letters refer to the medical test results and they are recognized, they may be validated as authentic values. If the numbers and/or letters are recognized, medical monitoring device 102 may be recognized in step 820, and the medical-monitoring-device-specific instructions may be used for analysing the image further.

In step 822, date and/or time is/are checked. If the date and/or time is/are recognized, they may be validated as authentic values. If the date and/or time is/are recognized, medical monitoring device 102 may be recognized in step 822, and the medical-monitoring-device-specific instructions may be used for analysing the image further. If the date and/or time is/are not recognized in step 822, the medical monitoring device 102 may not be recognized in step 822, and a further step 824 to 830 may be performed.

In step 824, measurement numbers of the test result are checked. If the numbers are recognized, they may be validated as authentic values. If the numbers are recognized, medical monitoring device 102 may be recognized in step 824, and the medical-monitoring-device-specific instructions may be used for analysing the image further.

In step 826, units and/or test mode markers of the test result are checked. If the units and/or test mode markers are recognized, they may be validated as authentic units. If the test mode markers are recognized, medical monitoring device 102 may be recognized in step 826, and the medical-monitoring-device-specific instructions may be used for analysing the image further.

In step 828, special spot and feature elements of the test result are checked. If the special spot and feature elements are recognized, they may be validated authentic. If the special spot and feature elements are recognized, medical monitoring device 102 may be recognized in step 828, and the medical-monitoring-device-specific instructions may be used for analysing the image further.

In step 830, other feature elements of the test result are checked. If the other feature elements are recognized, they may be validated authentic. If the other feature elements are recognized, medical monitoring device 102 may be recognized in step 830, and the medical-monitoring-device-specific instructions may be used for analysing the image further.

In step 832, it is checked if the medical monitoring device 102 is known on the basis of at least one of checks 808 to 830 performed. If the medical monitoring device 102 is not recognized, a new reference for the measurement device may be created and stored in the external entity 104 in step 834. The measurement device may be a new medical monitoring device.

In the step 832 the system checks if the device analysed is not known and not having instruction in the system yet. If not, then the system establishes a new device to the system, and uses the data extracted from the image in the establishment.

In step 838, the quality parameter value related to comparison output performed in step 836 is set.

In step 840, recognized measurement number i.e. value of the test result may be compared with at least on criterion associated with measured values.

In step 842, the recognized measurement numbers of the test result may be saved in a database of the external entity 104. Additionally, a quality value related to the measurement numbers may be saved.

All these operations 804 to 842 or some of the operations 804 to 842 may additionally or alternatively be performed in the portable electric device 100.

FIG. 11 presents flow chart of a recognition process performed in the external entity 104 or in the portable electric device 100. This shows a detail of step 810 of FIG. 9.

In step 900, feature data of at least one image may be extracted and analysed on the basis of steps 808, 812 to 816. In step 902, data pre-stored in the external entity 104 may be compared with the feature data extracted from the at least one image. In step 904, it may be determined that the medical monitoring device 102 is recognized and thus known, if the comparison between the extracted feature data and the feature data pre-stored in the external entity 104 matches. If the medical monitoring device in the at least one image is determined known, the medical-monitoring-device-specific instructions may be used for analysing the image further in step 906. If the medical monitoring device in the at least one image is determined unknown, the analysis process may continue in step 908.

FIG. 12 presents an example of data in a database of the external entity 104. The external entity 104 may have data of three different types of medical monitoring devices stored in is memory: a glucose measurement device 1, a glucose measurement device 2 and a blood measurement device 1. The external entity 104 may also recognize different features of the medical monitoring devices such as manufacturer, display size, logo, and text and its position because their information is pre-stored in the external entity 104. Further features may be added to the external entity 104.

FIG. 13 presents an example of data in a database of the external entity 104. In this example, the external entity 104 may have data of four different types measurements stored in is memory: a glucose measurement 2, a blood pressure measurement 1, a blood pressure measurement 2, and a urea measurement 1. The external entity 104 may also recognize different features of the measurements such as unit, minimum value, and maximum value because their information is pre-stored in the external entity 104.

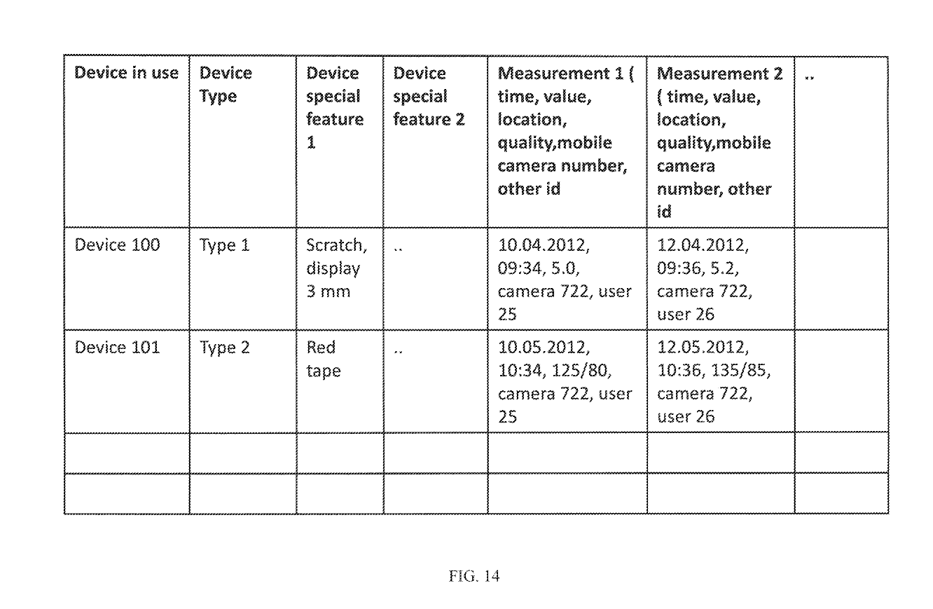

FIG. 14 presents an example of data in a database of the external entity 104. The data extracted from the at least one image of the medical monitoring device, which may include individual device specific features such as scratches, tapes etc., measurement results, and other data input from other ways such as ID, device information, time and date etc., relates to individual features of the medical monitoring devices. In this example, the external entity 104 may have data of two medical monitoring devices stored in is memory: device 1, device 2. The external entity 104 may also recognize different features of the medical monitoring devices such as device-specific special feature (scratch, tape attached to the device etc.) and device-specific feature related to measurement because their information is pre-stored in the external entity 104. The medical-monitoring-device-specific features may be device number, type number or the like. The medical-monitoring-device-specific features may also comprise measurement results.

It will be obvious to a person skilled in the art that, as technology advances, the inventive concept can be implemented in various ways. The invention and its embodiments are not limited to the example embodiments described above but may vary within the scope of the claims.

1. A portable electrical device comprising
a wireless transceiver;
a screen;
a digital camera;
a user interface;
a processing unit;
the processing unit is configured to acquire medical-monitoring-device-specific data as a plug-in from an external entity and configure an image capturing application of the portable electrical device with the medical-monitoring-device-specific data;
the digital camera is configured to capture at least one image of a location covering the screen of a medical monitoring device under control of the configured image capturing application in the processing arrangement, the screen assumed to display a medical test result of a person or an animal; and
the portable electrical device is configured to transmit the at least one image through the wireless transceiver to an external entity.

2. The portable electronic device of claim 1, wherein the processing unit comprises:
one or more processors; and
one or more memories including computer program code;
the one or more memories and the computer program code configured to, with the one or more processors, cause the portable electronic device at least to:
acquire medical-monitoring-device-specific data as a plug-in from an external entity;
configure the image capturing application of the portable electrical device with the medical-monitoring-device-specific data;
capture, under control of an image capturing application in the processing arrangement, at least one image of a location covering the screen of a medical monitoring device; and
transmit the at least one image through the wireless transceiver to an external entity.

3. The portable electronic device of claim 1, wherein the portable electrical device is configured to receive, with the wireless transceiver, the plug-in from the external entity.

4. The portable electrical device of claim 3, wherein the processing unit with the configured image capturing application is configured to guide the image capturing done by the portable electrical device.

5. An external entity comprising
a wireless transceiver;
one or more memories with identification data about at least one medical monitoring device; and
an processing arrangement;
the wireless transceiver of the external entity is configured to receive at least one image of a location of a screen of a medical monitoring device from a portable electrical device, the screen assumed to display a medical test result of a person or an animal;
the processing arrangement is configured to extract data from the at least one image for regaining a result about the medical test from the at least one image, and for comparing the extracted data with the reference data pre-stored in the one or more memories in order to ensure validity of the result about the medical test.

6. The external entity of claim 5, wherein the processing arrangement comprises:
one or more processors; and
one or more memories including computer program code;
the one or more memories and the computer program code configured to, with the one or more processors, cause external entity at least to:
receive at least one image of a location of a screen of a medical monitoring device from a portable electrical device, the screen assumed to display a medical test result of a person or an animal;
extract data from the at least one image for regaining a result about the medical test from the at least one image, and for comparing the extracted data with the identification data in the one or more memories in order to ensure validity of the result about the medical test.

7. The external entity of claim 5, wherein the wireless transceiver is configured to wirelessly transmit a plug-in to the portable electrical device, the plug-in configuring the image capturing application in the portable electrical device for capturing at least one image of the medical monitoring device.

8. The external entity of claim 5, wherein the processing arrangement is configured to recognize the medical monitoring device; if the recognition fails, the processing arrangement is configured to add a new identification data associated with the medical monitoring device in the at least one memory.

9. The external entity of claim 5, wherein the processing arrangement is configured to add the new identification data associated with the medical monitoring device in the at least one memory only after an approval by a super user of the external entity.

10. The external entity of claim 5, wherein the processing arrangement is configured to compare proportions of at least one part of the medical monitoring device shown in the at least one image for validating the extracted test result.

11. The external entity of claim 5, wherein the processing arrangement is configured to compare the value of the extracted test result with at least one predetermined criterion for determining reliability of the test result.

12. The external entity of claim 5, wherein the processing arrangement is configured to extract the unit of the test result and compare the extracted unit with at least one reference unit stored in the one or more memories for determining reliability of the test result.

13. The external entity of claim 5, wherein the external entity is configured to transmit, through the wireless transceiver, information about the analysis of the image back to the portable electrical device.

14. A system comprising a portable electrical device and an external entity; the portable electrical device comprising:
a wireless transceiver;
a screen;
a digital camera;
a user interface;
a processing unit; and
the external entity comprising:
a wireless transceiver;
one or more memories with identification data about at least one medical monitoring device; and
an processing arrangement; wherein
the processing unit is configured to acquire medical-monitoring-device-specific data as a plug-in from an external entity and configure an image capturing application of the portable electrical device with a medical-monitoring-device-specific data; the digital camera is configured to capture at least one image of a location covering the screen of a medical monitoring device under control of the configured image capturing application in the processing unit, the screen assumed to display a medical test result of a person or an animal; and
the portable electrical device is configured to transmit the at least one image through the wireless transceiver to the external entity; and
the wireless transceiver of the external entity is configured to receive at least one image of a location of a screen of the medical monitoring device from the portable electrical device; and
the processing arrangement of the external entity is configured to extract data from the at least one image for regaining a result about the medical test from the at least one image, and for comparing the extracted data with the reference data pre-stored in the one or more memories of the external entity in order to ensure validity of the result about the medical test.

15. The system of claim 14, wherein the system comprising the medical monitoring device comprising a screen, and the medical monitoring device being configured to process medical data of a test of a person or an animal, and to display processed medical data on the screen.

16. The system of claim 14, wherein the wireless transceiver is configured to wirelessly transmit a plug-in to the portable electrical device, the plug-in configuring the image capturing application in the portable electrical device for capturing at least one image of the medical monitoring device.

17. The system of claim 15, wherein the configured image capturing application is configured to guide the image capturing performed by the portable electrical device.

18. The portable electronic device of claim 2, wherein the portable electrical device is configured to receive, with the wireless transceiver, the plug-in from the external entity.

19. The external entity of claim 6, wherein the wireless transceiver is configured to wirelessly transmit a plug-in to the portable electrical device, the plug-in configuring the image capturing application in the portable electrical device for capturing at least one image of the medical monitoring device.
